(19) United States
(12) Patent Application Publication
(10) Pub. No.: US 2022/0366743 A1
(43) Pub. Date: Nov. 17, 2022

(54) TOKENIZED ACCESS TO SERVICES

(71) Applicant: FlashParking, Inc., Austin, TX (US)

(72) Inventors: Hunter Dunbar, Austin, TX (US); William Frank Kirwan, Austin, TX (US); Royce Wellington Higbee, Georgetown, TX (US)

(73) Assignee: FlashParking, Inc., Austin, TX (US)

(21) Appl. No.: 17/746,745

(22) Filed: May 17, 2022

Related U.S. Application Data
(60) Provisional application No. 63/189,551, filed on May 17, 2021.

(51) Int. Cl. G07C 9/00; G06Q 50/30; G06V 20/62

(52) U.S. Cl. CPC G07C 9/00309; G06Q 50/30; G07C 9/00896; G06V 20/625; G06V 2201/08

(57) ABSTRACT

Systems, methods, and hardware for enabling automated authorized access to services. The systems and methods enable a user having a user account to undertake actions equating to a request to access specific services, for an automated system to detect those actions and determine if the user is authorized to access such services and depending on the user's authorization level to either provide or restrict the user's access to such services.

### PRIORITY STATEMENT UNDER 35 U.S.C. § 119 & 37 C.F.R. § 1.78

This non-provisional application claims priority based upon prior U.S. Provisional Patent Application Ser. No. 63/189,551, filed May 17, 2021, in the names of Hunter Dunbar, William Fran Kirwan, and Royce Wellington Higbee entitled “TOKENIZED ACCESS TO SERVICES” the disclosures of which are incorporated herein in their entirety by reference as if fully set forth herein.

### FIELD OF THE INVENTION

The present disclosure relates to systems and methods for tokenized access to parking transactions and related services, and the generation of transactions related thereto.

### BACKGROUND OF THE INVENTION

Parking services have traditionally been monitored through the use of a physical ticket that is provided to the driver of a vehicle in order for them to gain access to a parking facility, such as an indoor or outdoor area for parking vehicles, including, for example, a parking garage, parking lot, parking ramp, car park, or the like, and which is recovered from the driver when they want to leave the parking facility. The ticket indicates the time of entry of the facility and that along with the time at which the ticket is recovered allows for the calculation of the vehicle's duration in the parking facility. This time period can then be used to calculate a fee amount which the driver of the vehicle must remit before they are permitted to egress from the facility. This system requires that the customer retain the physical ticket which they were issued until they leave the facility. Loss of a ticket can result in complications including the overcharging of customers as it is common for parking service providers to institute a high set fee in the event that a customer cannot provide their ticket and thereby corroborate their time of entry and duration of stay in the facility.

While some systems have automated this ingress/egress process by using technologies like RFID to identify vehicles authorized to enter and exit parking facilities such methods are generally limited to pre-authorized vehicles which operate on a prepaid flat fee, or bills to a previously established account, and does not take into account the actual time spent in the facility.

Furthermore, none of these systems enable the provision of premium services to customers when they are in the parking facility, much less in a manner that enables such services to be combined with the customers parking ticket.

Accordingly, there is a need for a system that can obviate the issues associated with the use of a traditional physical parking ticket, and which can also be used to control access to additional services, and to facilitate the automation of transactions related thereto.

### BRIEF SUMMARY OF THE INVENTION

The present disclosure teaches the use of vehicle recognition to enable tokenized access to services, such as: parking in premium parking spaces; accessing nested parking facilities; receiving electric vehicle charging services; obtaining access to an automated carwash; or receiving other such suitable services, any of which may come with an additional service charge.

The methods and systems taught herein may provide for an identified vehicle to receive a token authorizing that vehicle to receive one or more particular service(s).

Vehicle identification systems, which may use sensor(s) to uniquely identify a specific vehicle, such as license plate recognition (“LPR”), or matching vehicle features to a stored vehicle signature, may be used to identify a particular vehicle and associate it with a related account in a database. Once this is done services provide to the identified vehicle or its user(s) may be associated with transactions between the service provider and the account associated with that vehicle. Service providers may use a system to generate an authorization token for their services and associate it with both the identified vehicle and its associated account. The token may be received at a piece of service hardware, which, responsive to the receipt and validation of the authorization token, may permit access to service hardware so that the associated vehicle or user may receive the desired service(s). This way a customer may be able to receive automated access to premium services while they are parked in the parking facility, or before they exit the facility.

Provision of services permitted via an authorization token may be associated with the account linked to the identified vehicle and the authorization token. A transaction may be generated responsive to the receipt of services, and the transaction may be associated with the linked account and/or integrated into another transaction associated with the linked account or the authorization token.

Once the services linked to the authorization token have been provided the authorization token may then be revoked. Additionally, or in the alternative, if the services are only available at certain times, or the recipient of the authorization token only has access to the services for a set period, the authorization token may be configured to only allow access to the services at certain times, or to expire after a set term.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 depicts an exemplary embodiment of a system for the provision of tokenized parking and parking-related services, in accordance with embodiments;

FIG. 2 depicts a flow diagram showing steps for an exemplary method of tokenized access to services, in accordance with embodiments;

FIG. 3 depicts an alternate embodiment of a flow diagram showing steps for an exemplary method of tokenized access to services, in accordance with embodiments;

FIG. 4 depicts another alternate embodiment of a flow diagram showing steps for an exemplary method of tokenized access to services, in accordance with embodiments; and

FIG. 5 depicts a flow diagram illustrating a user-side view of a method of tokenized access to services, as depicted in FIG. 4 may observe, in accordance with embodiments.

### DETAILED DESCRIPTION OF ILLUSTRATIVE EMBODIMENTS

The configuration and use of presently preferred embodiments of the systems and methods for tokenized access to services are discussed in detail below. It should be appreciated, however, that the present invention provides many applicable inventive concepts that can be embodied in a wide variety of contexts other than parking facility management. Accordingly, the specific embodiments discussed are merely illustrative of specific ways to make and use the invention, and do not limit the scope of the invention.

Reference now should be made to the drawings, in which the same reference numbers are used throughout the different figures to designate the same components.

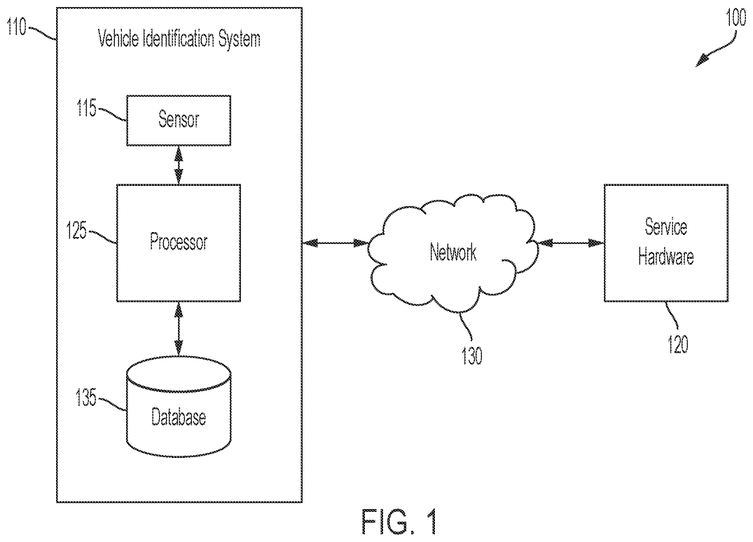

FIG. 1 shows a block diagram of an exemplary system 100 for implementing the methods of tokenized access to services discussed herein. System 100 may comprise vehicle identification system 110, processor 125, database 135, and service hardware 120, which may be communicably interconnected via network 130.

Vehicle identification system 110 may comprise one or more sensor(s), such as sensor 115, capable of distinguishing between individual vehicles. In embodiments sensor 115 may be a camera, an RFID reader, a Bluetooth beacon, etc. Embodiments of the vehicle identification system wherein sensor 115 comprises a camera may be configured to capture license plate information to individually identify vehicles via LPR or other visual vehicle information that permits the individual identification of a vehicle, such as but not limited to, capturing vehicle features in order to match them against known vehicle signatures stored in a database.

Once vehicle identification system 110 captures sensor information suitable to identify a vehicle that informing may be processed via processor 125 to positively identify a particular vehicle.

While vehicle identification system 110 and service hardware 120 may be located at a single location, such as a parking facility, so that they may both interact with vehicle and/or its driver; embodiments of system 100 may allow for its other constituent elements to be geographically distributed and communicably connected to one-another through a suitable communications network 130, such as the internet. For example, in embodiments, processor 125 may be located at a remote location, such as on a server that is in a location separate and distinct from the location of vehicle identification system 110. Similarly, database 135 may be at a location which may be separate and distinct from one or more of vehicle identification system 110, service hardware 120, or processor 125. Alternate embodiments may provide for processor 125 and/or database 135 to be collocated with, and a constituent part of, vehicle identification system 110.

Embodiments of service hardware, such as service hardware 120, may consist of one or more of a vast variety of different types of hardware. One embodiment of such service hardware may be, for example, an electric vehicle (EV) charging station. In such an EV charging station embodiment, the service hardware may comprise an EV charging station that comprises a transceiver for sending and receiving signals from a server processor, and a means for restricting access to a service associated with the service hardware (in this example EV charging capability). The transceiver may be configured to receive a validation signal from the processor indicating that the authorization token associated with the request for the EV charging services has been validated, and to transmit a signal to the processor indicating that the services have been completed or otherwise terminated. In this EV charging station example, the means for restricting access to the services, may comprises one or more of: a locking mechanism configured to physically prevent a user from being able to remove the charging plug from the charging station so that they are unable to connect said charging plug to their vehicle in order to receive the benefit of the EV charging services; and a relay configured to reversibly permit or restrict the flow of electricity from the EV charging station to a vehicle to which it is connected.

The validation of the authorization token and the transmission of the validation signal from the processor to the service hardware may be responsive to the vehicle identifications system determining that the identified vehicle associated with the authorization token is attempting to access the services from the services hardware. Such an indication may include, for example, the vehicle pulling up to a gate, the vehicle parking in a parking spot associated with an EV charging station, or the vehicle parking in a premium parking spot, etc.

In embodiments, service hardware, may further comprise anti-tampering components, such as, for example, one or more sensors configured to detect undesirable activity (e.g., physical tampering with the service hardware), and visual alarms configured to activate visual, and/or auditory alarms configured to activate (i.e., by flashing lights, making noise(s), or making announcements, etc.) responsive to the sensors' determination that undesirable activity is ongoing. Alternatively, the alarms may be triggered by the vehicle identification system's detection of undesirable activity. Such undesirable activity that may be detected by the vehicle identification system may include, for example, an unauthorized vehicle attempting to access the services associated with the service hardware. For example, if a vehicle that is not authorized to use an EV charging station, or which does not have an authorization token that is valid for EV charging services parks in a space that is associated with an EV charging station, the vehicle identification system may identify this and trigger the EV charging station to flash lights, or make an announcement that the vehicle is not authorized to park in that parking spot.

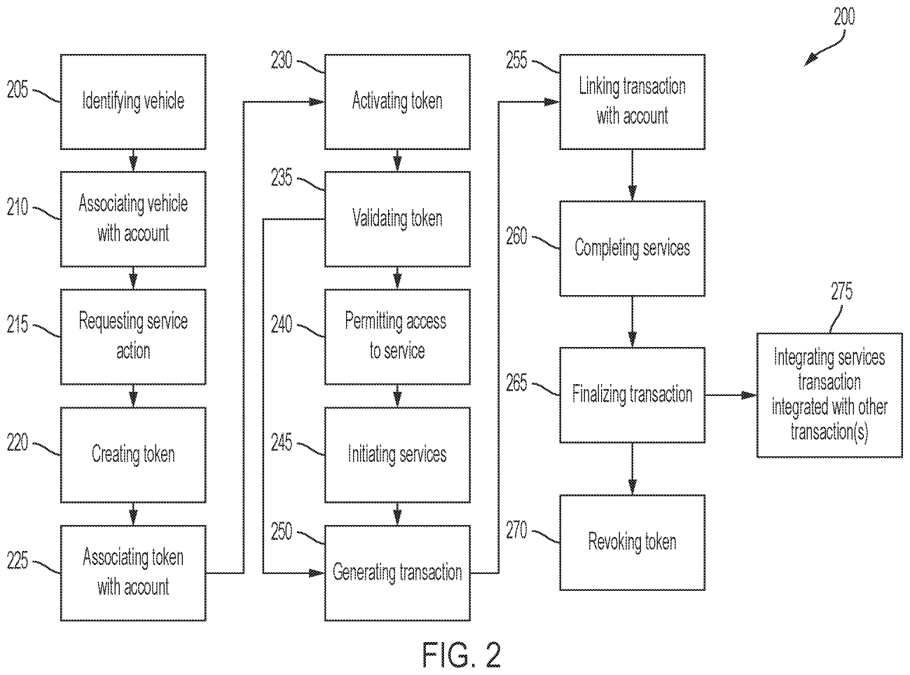

FIG. 2 provides a flow diagram depicting an exemplary method of tokenized access to services, namely method 200, by which a customer may be provided with services via use of an authorization token and invoiced for such services automatically. The embodiment of the method depicted in FIG. 2 may begin with a vehicle identification system, such as vehicle identification system 110, identifying 205 a vehicle. Once the vehicle identification system individually identifies a vehicle, method 200 may proceed to the step of associating 210 the identified vehicle with an account that has been previously created and stored in a database, such as database 135, connected to the vehicle identification system. The identified vehicle, or a user thereof may then take an action associated with the requesting 215 of the performance of a service. In embodiments, the action associated with the requesting 215 of the performance of a service may be identified via a vehicle identification system, such as vehicle identification system 110. In response to the requesting 215 of a service, the system may perform the step of creating 220 an authorization token for the associated service, which may be performed by a processor, such as processor 125. Once the authorization token is created, the system may perform the action of associating 225 the authorization token with the account with which the identified vehicle itself was associated in step 210. Once the authorization token has been created and associated with the vehicle's account, the system may perform the step of activating 230 the authorization token. Once activated, the authorization token may be validated 235 by one or more of the service hardware, the vehicle identification system, or the processor. In response to the validation of the authorization token the system may take the step of permitting 240 the holder of the authorization token to access the service associated with the service hardware associated with the provision of the services for which the authorization token has been created and/or associated. After the system permits access to the applicable service hardware, the holder of the authorization token may begin initiating 245 their use of the service. Completion of the step of validating 235 the authorization token may also trigger the system to perform the steps of generating 250 a transaction for the service and linking 255 said transaction with the account associated with both the identified vehicle and the authorization token. After completing 260 the performance of the authorized service, the system may take the step of finalizing 265 the transaction and revoking 270 the authorization token and/or its authorization specific to the completed service. After the authorization token or its authorization of said service is revoked then its holder will no longer be permitted further access to the service. Finally, if desired, the system may perform the step of integrating 275 the finalized transaction associated with the completed service with one or more other transactions associated with the identified vehicle.

In embodiments, the action associated with the requesting 215 of the performance of a service may comprise entering into or parking in a designated location associated with the service and/or service hardware. For example, a vehicle approaching and stopping in front of a gate may trigger the generation of a request to access the gated portion of a parking facility, while a vehicle parking in a parking spot associated with an EV charging station may trigger the generation of a request to access EV charging services.

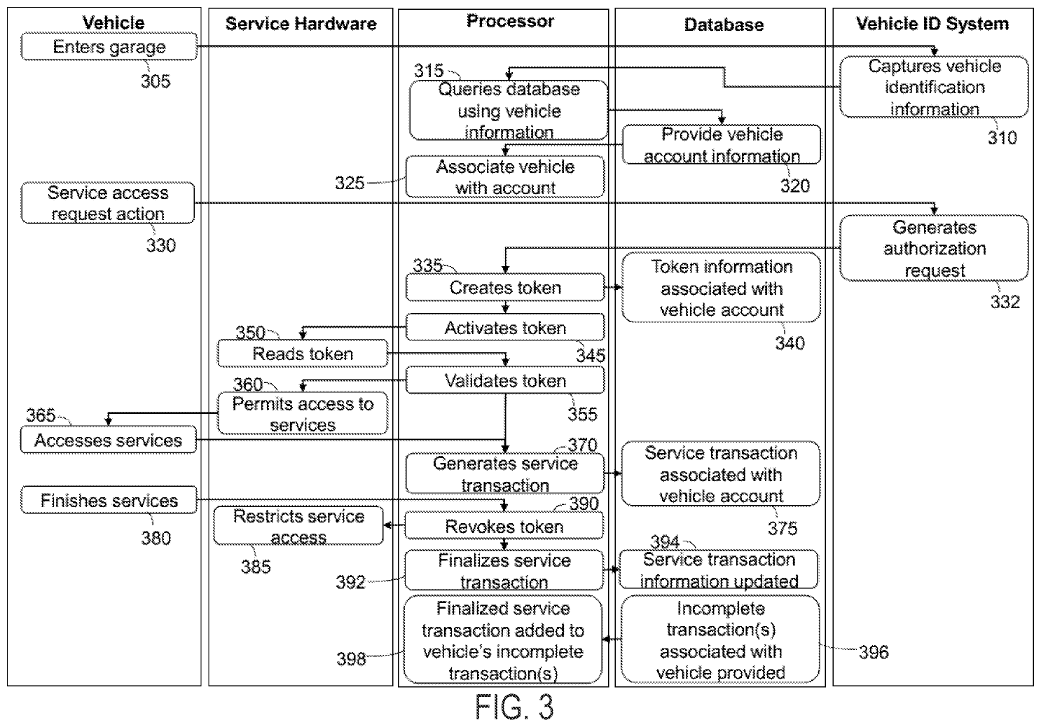

FIG. 3 depicts an alternate embodiment of a flowchart depicting an exemplary method of providing tokenized access to services, namely method 300. In the embodiment depicted in FIG. 3, when a vehicle enters 305 into a parking facility a vehicle identification system, such as vehicle identification system 110, may capture 310 vehicle identification information from vehicle. The captured vehicle identification information may be sent to a processor, such as processor 125, which may then query 315 a database, such as database 135, to lookup an account associated with that vehicle information. The vehicle may then be associated 325 with the relevant account in the database. The vehicle may make a service request action 340 indicating that it desires a service be provided. In response to service request action 340 the system may generate 322 a service authorization request at either the vehicle identification system or the processor. Once the system receives a service authorization request, an authorization token may be created 335 and associated 340 with and stored in the vehicle's account. After its creation 335 the authorization token may be activated 345. Service hardware 120 may read 350 the activated authorization token and the read token may be validated 355. In response to validation 355 of the authorization token service hardware, such as service hardware 120, may permit 360 access to the services associated with the authorization token and the service request action 330, after which the vehicle may access 365 said services. In response to one or more of validation 355 of the token or the vehicle's accessing 365 the services, a service transaction may be generated 370 and associated 375 with the vehicle's account. Once the vehicle finishes 380 the services the authorization token may be revoked 390. Responsive to the revocation 390 of the authorization token, service hardware may restrict 385 access to the services and the service transaction may be finalized 392. Once finalized 392 the service transaction information in the database may be updated 394. Optionally, incomplete transaction information may be provided 396 by the database and the finalized service transaction may be added 398 to the other incomplete transaction information associated with the vehicle.

In embodiments, the service action request 330 may comprise actions such as, but not limited to, parking in a premium parking spot (e.g., a parking spots close to the exit of the parking facility, close to an elevator bank or stairwell, close to the entrance of a building, or outfitted with an electric vehicle charging station, etc.), thereby effectively forming a virtual nested garage. In alternate embodiments, the service action request 330 may comprise actions such as approaching a gate, or entering a particular location, such as, for example, the entrance to an automated car wash.

In embodiments, the step of permitting 360 access to a service may comprise sending a signal to the service hardware that causes said service hardware to take an action which allows the vehicle to access 365 the services provided by said service hardware. Examples of such actions that the service hardware may take to permit 360 access to their related services include, but are not limited to, opening a gate to permit physical passage of the vehicle, mechanical unlocking of a vehicle charging stations plug, providing electrical power to a vehicle charging station, or activating an automated car wash.

According to some embodiments, once the transaction for services has been finalized it may be integrated with one or more other transactions associated with the same account, so that such transactions may be billed to the customer account together. The system may then use payment information stored in the user account to complete the transaction.

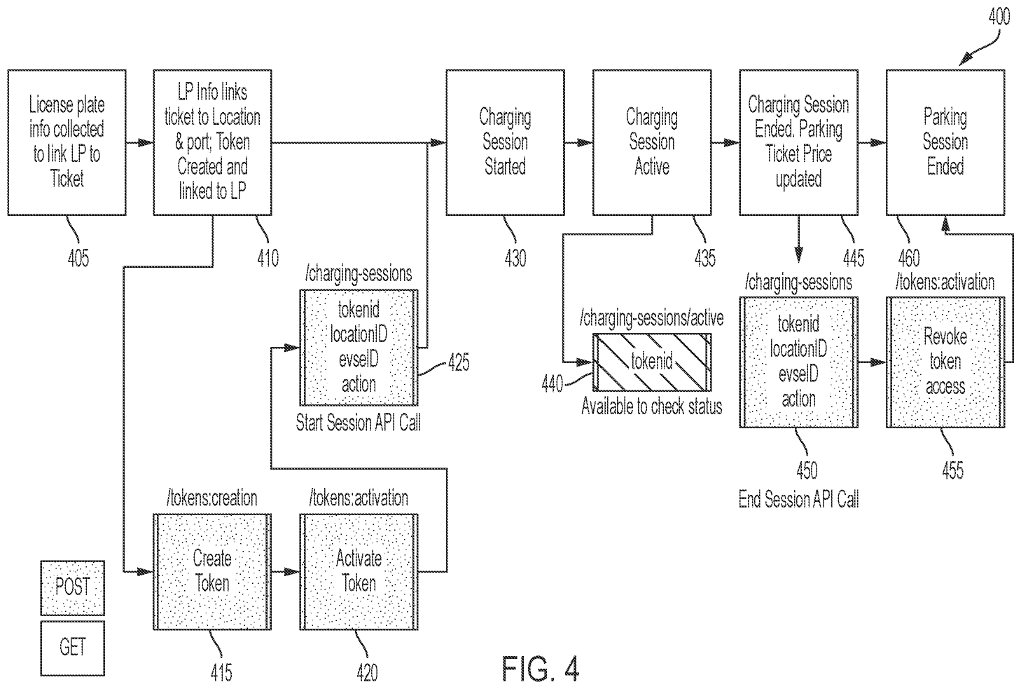

FIG. 4 depicts an alternate flowchart depicting an exemplary embodiment of a method for tokenized access to services. In this embodiment, license plate information may be collected 405 from a vehicle so that a license plate can be linked to a ticket for a transaction. The collected license plate information may be linked 410 to other information such as the location of the vehicle bearing the license plate and the parking spot in which it is located. A token may then be created 415, activated 420, and linked 410 to a service and the ticket. Once a service, such as electrical charging of the vehicle associated with the license plate starts 430 and the service is active 435 the token may be updated 440 with information related to the service session. Once the service ends 445, which may include updating 445 the ticket associated with the service, the token may be updated 450 again after which the token may be revoked 455. Once the token has been revoked 455 the system may deem the service session to have ended 460.

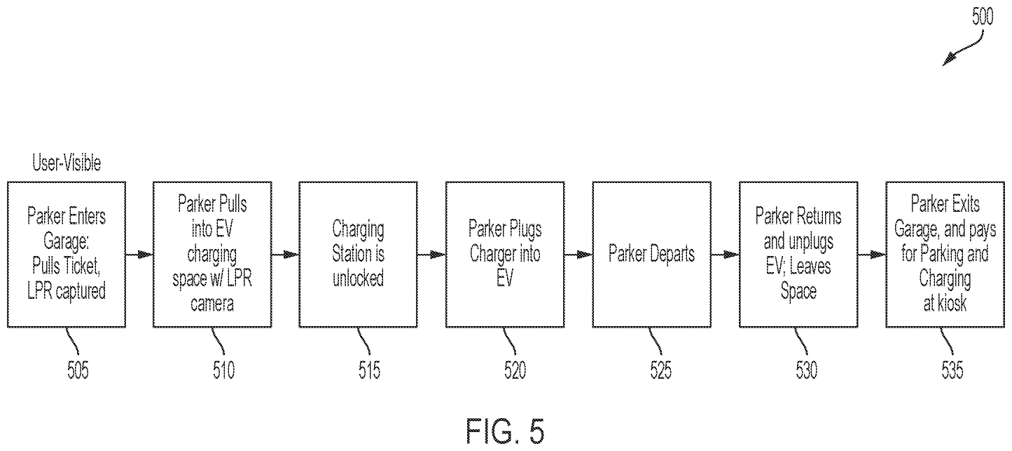

FIG. 5 depicts a flowchart showing the steps that may be observed by a user of one or more of the embodiments of a method for tokenized access to services methods described in one or more of FIGS. 2-4. The user may enter 505 a parking facility. They may then park 510 in a parking spot associated with a service such as the charging of an electric vehicle. Once the user parks 510 in the service parking spot they may be notified 515 that the service has become accessible, such as by the unlocking of the parking spot's associated charging station. The user may then plug 520 the charging cord into their vehicle, after which they may generally go about their business, departing 525 from the vehicle location. Once the user returns to their vehicle, they may unplug 530 the charging plug, thereby terminating the charging services and exit 535 the parking facility. When exiting 535 the parking facility the user may pay for both the parking services and the vehicle charging services at a payment kiosk or by other suitable means, such as by mobile application.

As briefly touched on in some of the paragraphs hereinabove, an exemplary service that may be provided for by the methods described herein is that of charging an electric vehicle. In such a scenario a vehicle may enter a parking garage. While entering or while inside of the garage a vehicle identification system, such as an LPG system, may be used to identify the vehicle. The identified vehicle may be associated with an account that is known to the system. The system may generate an access token which is then linked to one or more of the vehicle(s) and its associated account. Once generated, the token may then be activated for one or more particular services, such as for the purpose of allowing the identified vehicle the use of a charging station located in the garage. The system may receive and validate the authorization token, and in response permit use of the charging station, such as by unlocking the charging station hardware and/or activating the charging station. Once the charging station has been activated a user may begin charging the authorized vehicle using the charging station. The system may track the charging session and generate a transaction for the use of the charging station. This transaction may be associated with the identified vehicle and its associated account. Once the user has completed their charging session, the transaction may be finalized, and a ticket associated with the vehicle and its associated account may be updated. The authorization token may also be revoked responsive to the completion of the charging session. Once the authorization token has been revoked the system may terminate access to the services, such as by turning off the charging station and/or locking down the charging station hardware.

Some exemplary services that the disclosed methodology could cover include, but are not limited to: oil changes, EV charging, induction charging, priority parking (virtually nested garages and physically nested garages (separated by gates)), automated car washes or vacuum stations, takeout food services, etc.

While the present system and method has been disclosed according to the preferred embodiment of the invention, those of ordinary skill in the art will understand that other embodiments have also been enabled. Even though the foregoing discussion has focused on certain embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

Any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including Substantially concurrently in reverse order, depending on the functionality involved, as would be understood by those reasonably skilled in the art of the present invention.

Considering the wide variety of methods for parking management known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step, or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the claim.

1. A system for tokenized access to services, comprising:
a database comprising a user account, the user account comprising vehicle information and payment information;
a vehicle identification system configured to identify a vehicle, and to generate an authorization request responsive to its detection of the vehicle engaging in an action associated with a service;
a processor configured to associate the vehicle with the user account via the vehicle information, to receive the authorization request from the vehicle identification system, to generate and activate an authorization token configured to permit access to the service responsive to the receipt of the authorization request, to associate the authorization token with the user account, and to validate the authorization token;
service hardware configured to restrict access to the service prior to validation of the authorization token, to provide access to the service responsive to validation of the authorization token, to transmit a service termination signal to the processor upon completion of the service, and to restrict access to the service responsive to revocation of the authorization token;
wherein the processor is further configured to generate a service transaction associated with the validated authorization token and link the service transaction to the user account, to revoke the authorization token responsive to receipt of the service termination signal, to finalize the service transaction once the authorization token has been revoked, and to initiate a financial transaction corresponding to the finalized service transaction, wherein said financial transaction uses the payment information; and
wherein the processor is communicably connected to the vehicle identification system, the database, and the service hardware via a network.

2. The system of claim 1, wherein the vehicle identification system comprises a camera and is configured to perform license plate recognition to identify the vehicle.

3. The system of claim 1, wherein the action associated with a service comprises the vehicle occupying a designated location of a parking facilities.

4. The system of claim 3, wherein the designated location comprises a location proximate to the service hardware.

5. The system of claim 3, wherein the designated location comprises a parking space.

6. The system of claim 1, wherein the service hardware comprises:
a means for restricting access to the service configured to default to a state by which it restricts access to the service;
a transceiver configured to receive one of a validation or a rejection of the authorization token from the processor, and to send the service termination signal to the processor responsive to completion of the service; and
wherein the means for restricting access to the service is further configured to permit access to the service responsive to receipt of the validation of the authorization token.

7. The system of claim 6, wherein the means for restricting access to the service comprises a lock.

8. The system of claim 6, wherein the means for restricting access to the service comprises a relay.

9. The system of claim 6, wherein the service hardware is further configured to restrict access to the service responsive to revocation of the authorization token, via the means for restricting access to services.

10. The system of claim 1, wherein the service hardware comprises an automated car wash.

11. The system of claim 1, wherein the service hardware comprises an electric vehicle charging station.

12. The system of claim 1, wherein the service hardware comprises a gas pump.

13. The system of claim 1, wherein the service hardware comprises a gate.

14. The system of claim 1, wherein the service hardware comprises a vacuum.

15. A method for providing access to services using an authorization token, comprising the steps of:
restricting access to a service associated with service hardware;
generating an account comprising vehicle information and payment information;
generating a request for the service responsive to observation of a vehicle taking an action associated with the service;
generating an authorization token for the service;
associating the authorization token with the account;
activating the authorization token;
validating the authorization token;
transmitting the validation of the authorization token to the service hardware;
permitting access to the service at the service hardware responsive to validation of the authorization token;
generating a service transaction for the service;
linking the service transaction to the account; and
completing a financial transaction for the service transaction using the payment information.

16. The method of claim 15, further comprising the step of revoking the authorization token responsive to termination of the service.

17. The method of claim 15, further comprising the step of associating the service transaction with a second transaction associated with the account prior to the step of completing the financial transaction.

18. Service hardware comprising:
a means for restricting access to a service provided by the service hardware;
a designated location configured such that a vehicle detected in the designated location generates a request to access the service;
a transceiver configured to receive one of a validation or a rejection of an authorization token responsive to the request to access the service, and to transmit a service termination signal responsive to completion of the service;
wherein the means for restricting access to services is further configured to permit access to the service responsive to validation of the authorization token; and
wherein the service hardware is configured to restrict access to the service prior to validation of the authorization token, to provide access to the service responsive to the validation of the authorization token, and to restrict access to the service responsive to revocation of the authorization token.

19. The service hardware of claim 18, wherein the validation or rejection of the authorization token is received from a server via a network, and wherein the service termination signal responsive to completion of the service is transmitted to the server.

20. The service hardware of claim 18, wherein the detection of the vehicle in the designated location is performed via a vehicle detection system.
